(19) United States
(12) Patent Application Publication
(10) Pub. No.: US 2014/0268697 A1
(43) Pub. Date: Sep. 18, 2014

(54) Dual AC-LED/DC-LED Lamp With Alternating Power Sources

(71) Applicant: C-M GLO, LLC, Watertown, WI (US)

(72) Inventors: Aaron W. Smith, Watertown, WI (US); Chamy Chiachen Lutz, Oconomowoc, WI (US)

(73) Assignee: C-M Glo, LLC, Watertown, WI (US)

(21) Appl. No.: 13/804,008

(22) Filed: Mar. 14, 2013

(51) Int. Cl. F21L 4/08; F21L 4/02

(52) U.S. Cl. CPC F21L 4/08; F21L 4/02
USPC 362/183; 362/184; 362/235

(57) ABSTRACT

A lighting device includes two different types of light emitting elements and two different types of power sources for selective illumination. In particular, the lighting device has AC-LEDs and DC-LEDs that are illuminated by an AC power source and a DC power source, respectively, without the need for current conversion. The AC-LEDs and DC-LEDs may be disposed within a LED lamp which is installable in any preexisting light fixture.

### BACKGROUND OF THE INVENTION

The present invention relates to a light device utilizing two different types of light emitting elements and two different types of power sources. In particular, the present invention relates to a light device having both an AC power supply and a DC power supply providing power to AC-LEDs and DC-LEDs, respectively, without the need for current conversion.

A light emitting diode (LED) is a semiconductor that gives off light when current is passed through it. The light emitted by these elements resembles most incandescent or compact fluorescent (CFL) light bulbs but may be preferred because they consume less electricity and last longer. In addition, compared to incandescent or CFL bulbs, LED bulbs are generally smaller in size, are more durable and reliable, and can better withstand extreme temperatures.

LEDs were first designed to be used in circuits that run on low-powered direct current (DC). They were often used in low lighting applications, such as in an exit sign, a power button on a computer, or a light on a video camera. Subsequently, high-powered LEDs have also been developed to illuminate a larger area, such as flashlights, light bulbs, or integrated light fixtures. However, LEDs are still typically powered by a DC power source, such as a battery, where current runs in one direction only.

In contrast to DC power which suffers losses over distances, AC performs better over long distances and can transmit larger amounts of power. Because of these advantages, the average household outlet runs on AC power, a current incompatible, at least in its direct form, with most LEDs. Therefore, it has been a requirement of LED lighting devices to also have intervening electronics that will convert incoming AC power to the proper DC power voltage. An LED-based fixture deriving power from a main utility supply (e.g., 120 V AC) generally requires electronics located between the power supply and the fixture itself to provide a DC voltage (e.g., 12 V DC) capable of driving several LEDs.

Some lighting devices have utilized drivers or transformers between the building wiring or wall socket and the fixture to provide the required DC voltage to the lighting device. Other lighting devices, such as LED light bulbs, include built-in drivers or transformers for performing such a function. The need for a driver or transformer can be very space consuming, especially if required to fit within a standard light bulb encasement. Additionally, the additional component of a driver or converter renders the electrical components less stable and more prone to failure. The heat derived from the use of a driver or converter often puts the components at greater risk for electrical failure.

However, a new approach for lighting has been the development of AC-LEDs, which can operate directly from an AC power supply. These AC-LEDs can handle a higher voltage (e.g., 32 V) and can accept an AC voltage directly, without AC to DC conversion. Several methods of creating the AC-LEDs have been employed. For example, a method developed by Seoul Semiconductor takes two strings of series-connected die, connected in different directions whereby one string is illuminated during the positive half of the AC cycle, the other during the negative half. The strings are alternately energized and de-energized at the 50/60 Hz frequency of the AC main power source, and thus the LED always appears to be energized. It is recognized that other methods for making an AC-LED have been developed. Through these methods, the AC-LEDs can transmit power more efficiently and effectively, without the need for intervening electronics.

The present invention seeks to improve upon such prior art by providing a lighting device having both AC-LEDs and DC-LEDs, such that the lighting device can be illuminated by both AC current and DC current without requiring conversion of the source current.

### SUMMARY OF THE INVENTION

The present invention is generally directed to a lighting device having two types of LEDs connected to, and alternatively powered by, two types of power sources. The lighting device has both AC-LEDs which can be powered directly by AC current, and DC-LEDs which can be powered directly by DC current. The lighting device is generally powered by connecting the device to AC utility power via a building wiring, a wall outlet, plug, or socket. In the instance when AC utility power is delivered, AC power is delivered to AC-LEDs and the AC-LEDs are illuminated. In the instance when the power source is switched, either automatically or manually, the DC power is delivered to DC-LEDs and the DC-LEDs are illuminated. In this arrangement, the need for current conversion is eliminated while allowing the lighting device to be illuminated by dual-power sources.

In one embodiment, the LEDs are located in a LED bulb or LED lamp, which may be inserted into any standard household lamp or light fixture. The household lamp or light fixture is electrically connected or hardwired to an AC power supply. The LED bulb may have a built-in battery, thus providing an alternative power supply. Alternatively, the battery may be coupled to the LED bulb but exterior to the LED bulb.

The user may insert the LED bulb into a preexisting lamp or light fixture socket to electrically connect the bulb with the AC power supply. During normal operation, AC power is supplied to illuminate the AC-LEDs. During a power outage, or when AC power is otherwise interrupted, the power source is switched to emanate from the battery which supplies DC power to illuminate the DC-LEDs.

Additionally, a controller may control the amount of power output that is delivered to the device, for example, to limit the power output to conserve battery power or to provide a visual signal to the user that the device is now running on the back-up source. A visual or audio signal may also alert the user to a low battery situation and allow the user to replace the battery to prolong illumination.

### BRIEF DESCRIPTION OF THE DRAWINGS

The drawings illustrate the best mode presently contemplated for carrying out the invention.

In the drawings:

FIG. 1 is a schematic drawing of a representative application of the lighting device of the present invention, in the form of an emergency lighting system in showing the interconnection between a transmitter, power outlet, and receiver(s);

FIG. 2 is an illustration of the emergency lighting system of FIG. 1 showing the wall transmitter interacting wirelessly with a receiver located in a ceiling light fixture;

FIG. 3 is an exploded isometric view of the wall transmitter of FIG. 2;

FIG. 4A is a side elevation view showing the LED lamp of FIG. 2;

FIG. 4B is an exploded isometric view of the LED lamp of FIG. 4A;

FIG. 5 is a side elevation view of an alternative embodiment of the present invention in the form of a two-piece LED lamp and receiver combination;

FIG. 6 is a schematic representation of an alternative embodiment of the present invention in the form of a light fixture having a built-in receiver;

FIG. 7A is a schematic drawing of a circuit board coupled to a receiver, which is incorporated into the light assembly;

FIG. 7B is a side elevation view showing the circuit board of FIG. 7A;

FIG. 7C is a schematic drawing of an alternative embodiment of a circuit board with an integrated receiver, which is incorporated into the light assembly;

FIG. 7D is a schematic drawing of an alternative embodiment of the circuit board of FIG. 7C having an alternative configuration;

FIG. 8 is a schematic block representation of the electronic arrangement incorporated into the light assembly;

FIG. 9 is a schematic block representation of an alternative embodiment of the electronic arrangement incorporated into the light assembly;

FIG. 10 is a circuit diagram showing the light engine of FIG. 8; and

FIG. 11 is a circuit diagram showing the light engine of FIG. 9.

### DETAILED DESCRIPTION OF THE DRAWINGS

This invention relates to a lighting device that can be powered with either AC power or DC power, such as for use in an emergency lighting device including a number of light-emitting elements configured to operate in combination with one another and including a means for detecting a loss of power condition.

Referring to FIG. 1, a schematic drawing of an emergency lighting system 10 incorporating one or more lighting devices according to the present invention is shown. In the emergency lighting system 10, a transmitter 12 is provided for detecting the loss of primary power. The transmitter 12 is coupled to a standard power outlet 16 and is able to detect a loss of power condition at the power outlet. It is understood, however, that the transmitter 12 may also be hard-wired into the electrical system of a building. It is contemplated that the detection may be made whether the loss of power is due to a power failure or by manually shutting off power to the outlet, such as by a switch. The transmitter 12 is configured to be in operable communication with a number of receivers 14 disposed about a given location and each in operable communication with a lighting device according to the present invention. In this manner, the transmitter 12 may be configured to send a signal, e.g., a radio frequency (RF) signal, to each of the receivers 14 when primary power is lost such that each of the receivers 14 is then configured to switch to emergency mode whereby light-emitting elements of the lighting device are illuminated and powered by a backup power source. Understandably, the system 10 may be configured so as to incorporate a number of transmitters 12 configured to be in wireless communication with a number of receivers 14 wherein each of the number of transmitters 12 is assigned to a predetermined subset of receivers. In this manner, relatively larger areas may employ the system 10.

It is contemplated that the emergency lighting system 10 may be configured to communicate through a wireless communication network, e.g., a Wi-Fi or ZigBee network. For example, a ZigBee network may be favorable as it provides a network architecture ideal for applications requiring a low data rate, long battery life and secure networking. A ZigBee transceiver may be coupled to transmitter 12 to transmit communication data to receivers 14. A ZigBee chip may be coupled to receivers 14 to accept communication data when there is a loss of power at transmitter 12. Additionally, other devices, such as cell phones and tablets which are connected to the network wirelessly or via a wireless “cloud”, may also communicate with the system 10 and control the lighting device. This allows the user to control the lighting device remotely, for example, when the user is away from home or away from the building. It is also contemplated that the user may use a remote control to communicate with the lighting device via RF signal or infrared signal.

Referring now to FIG. 2, a representative embodiment of the emergency lighting system 10 is shown. In the illustrated embodiment, the lighting device 20 is a single unit light bulb or lamp that can be employed in any light fixture (as shown), such as a ceiling, wall or floor light fixture, or any household ground lamp. The light bulb or lamp may include a number of light-emitting elements 24 such as, for example, light emitting diodes (LEDs) or other such elements capable of emitting light for providing illumination during a loss of power condition. The lighting device 20 may include a lamp 22 for securely housing the light-emitting elements 24, which may further include a lens or other means for projecting the light emitted by the light-emitting elements 24 in a predetermined manner.

An electronics arrangement 26 may be coupled to the lighting device to provide the necessary circuitry and electronics for operation with a controller, such as a printed circuit board. A housing may be provided to house the electronics arrangement operably coupled with the light-emitting elements 24 to selectively operate the light-emitting elements as will be discussed. Alternatively, the electronics arrangement 26 may be housed entirely within lamp 22.

The receiver 14 of the lighting device 20 is in operative communication with the electronics arrangement 26. The receiver 14 may be a wireless receiver configured to operate via RF, WiFi, ZigBee, or by any other similar such wireless communication standard. The receiver 14 may be in communication with the transmitter 12, which may be in the form of a wireless transmitter configured to transmit signals to the receiver as will be described.

Referring now to FIG. 3, the transmitter 12 may include a housing 30 for securely housing the transmitter circuitry and associated electronics. The housing 30 may include a number of electrical connectors 32 such as prongs or the like for interconnecting the transmitter 12 to a wall outlet, plug or socket for providing power to the transmitter.

The transmitter 12 may additionally include a transmitter backup power source 34 such as a battery or the like. The transmitter backup power source 34 may be a rechargeable battery such that when the transmitter 12 is coupled to the wall outlet, plug or socket, the transmitter backup power source 34 is charged so as to be operable in the instance of a power loss.

The transmitter 12 may further include a sensor 36 configured to detect a power loss condition. Once the sensor 36 detects a power loss condition, the sensor 36 relays a signal to the electronics arrangement 18, which then transmits the signal to the receiver 14. The sensor 36 may be configured in a number of different ways such that it only detects power loss conditions of a predetermined duration such that temporary losses in power do not result in the transmission of a signal from the transmitter 12. The sensor 36 may be configured so as to be able to distinguish between a power loss event where no power is available at the outlet or power source and a switch that may be operable via a wall switch or some other means whereby power is still available at the given outlet although not present. It is also contemplated that the sensor may detect other conditions besides power loss, such as carbon monoxide, smoke, heat, motion or sound. The transmitter may further include a transceiver for communicating with a wireless network, such as WiFi or ZigBee.

The transmitter 12 may also include a lighting feature 38, such as an LED panel or small output incandescent light bulb, which may serve as a nightlight or flashlight. The lighting feature 38 may be powered by the utility power or battery power of the transmitter 12, and may be configured to illuminate only during certain lighting conditions, such as during a black-out or low lighting conditions.

Referring now to FIGS. 4A and 4B, one representative embodiment of the receiver is a lighting device 20, such as a LED bulb or LED lamp having a built-in electronics arrangement 26. The lighting device 20 is operably coupled to the printed circuit board or control board 40 to illuminate the light-emitting elements 24 of the LED lamp upon receipt of a signal from the transmitter 12 indicating that there has been a power outage. The electronics arrangement 26 of the lamp may include a sensor 44 for detecting a loss of power. The sensor 44 may be operably coupled with a control board 40 that is operable to receive an indication from the sensor 44 that power to the lighting device 20 has been lost. The control board 40 may then be configured to selectively operate the lighting device 20 on a backup power source such as a battery 46. The backup power source may be external to the lighting device 20 or built into the lighting device 20.

The lighting device 20 may include a power coupling element 42 such as, for example, an electrical contact, prongs or the like configured to be selectively coupled with an external power source such as a standard outlet or light fixture. In this manner, the lighting device 20, via the control board 40, may be configured to operate off an external power source when primary power is available and then switch to the backup power source 46 upon detection of a power loss by sensor 44. The backup power source 46 may be rechargeable such that when the lighting device 20 is operating on primary power, the backup power source 46 is recharged.

When power is present, the lighting device 20 may be configured to be powered from the primary power source via a traditional wall outlet, socket or fixture as previously discussed, or, in the alternative, as desired, the lighting device 20 may be disconnected from any permanent power source and configured to only illuminate upon occurrence of a power outage wherein the lighting device 20 is powered via the backup power source 46. During a power outage, the lighting device 20 is configured to operate off the backup power source 46.

As indicated previously, once the receiver 14 receives the signal from the transmitter 12 indicating a loss of power, the receiver 14 relays the signal to the control board 40, which then directs the electronics arrangement 26 to enter an emergency mode in which the light-emitting elements 24 are illuminated to provide illumination in and around the area of the lighting device 20. In one construction, the light device may have an antenna for receiving the signal from transmitter 12 from a farther distance.

In the representative embodiment, the lighting device 20 contains light emitting elements 24 in the form of an LED module having a plurality of LEDs 24a, 24b. The plurality of LEDs may be on an LED chip. The device also contains an electronics arrangement 26 and a heat sink 48. The heat sink 48 may be, e.g., an aluminum disk or other heat conducting material, which dissipates the heat from within the LEDs themselves. In accordance with the present invention the LED module may include two types of LEDs to prevent the need for electronics, such as an AC/DC converter or driver, between the lighting device and the power supply. The lighting device may contain a plurality of AC-LEDs 24a which can operate directly off an AC power supply. Thus, the lighting device has the capability of being illuminated by AC utility power without converting the current. The lighting device also contains a plurality of DC-LEDs 24b which can operate directly off a DC power supply. Thus, the lighting device has the capability of being illuminated by DC power without converting the current. It is contemplated that the number of DC-LEDs 24b is less than the number of the AC-LEDs 24a in order to conserve the energy delivered from the backup power supply, namely, the battery. However, any number or configuration of the two types of LEDs may be presented. By utilizing dual types of LEDs, power is transmitted more efficiently and power is delivered more effectively without the need for intervening electronics.

The lighting device 20 may be configured to illuminate all or a subset of the light-emitting elements 24 at full or partial power. In addition, the light-emitting elements 24 or a subset thereof, may be flickered, sequenced, repeatedly turned on and off, etc. In this manner, the lighting device 20 may be configured to provide illumination while still conserving power to prolong the battery life and extend the duration of operation. In at least one construction of the lighting device 20, the lighting device may be configured so that as the battery power is expended the number of operable light-emitting elements 24 and/or intensity of the light-emitting elements 24 is reduced. The lighting device 20 may include means, such as a mechanical switch, for setting the light-emitting elements 24 to operate in a predetermined mode such that a user of the lighting device 20 may select a predetermined manner of operation. For instance, the lighting device 20 may incorporate a button, toggle, chain, or the like for switching between the different illumination modes of the light-emitting elements 24. In at least one construction of the present invention, the lighting device 20 may be configured so that a signal may be sent from the transmitter 12 to the receiver 14 of the lighting device to indicate a given mode of operation.

In one construction of the lighting device of the present construction, the lighting device 20 may additionally include a photosensor element 50 configured to detect the presence of natural light. Moreover, the photosensor element 50 may be operably coupled with the control board 40 to prevent operation of the lighting device 20 during daytime hours to conserve on power consumption.

As previously discussed, the backup power source 46 may be one or more rechargeable batteries or may be a standard battery. In either case, the lighting device 20 may be configured to detect a low battery condition such that upon occurrence of a low battery level, the lighting device 20 may be configured to notify an operator that the battery needs to be recharged and/or replaced. The lighting device 20 may be configured to notify the operator via an audible or visual indication such as through the transmission of a sound or the illumination of an indicator light or in any other such manner known in the art.

It is contemplated that the lighting device 20 may be a wide variety of lighting types, fixtures, and arrangements. For example, the LED lamp may be constructed to fit into preexisting down lighting or linear lighting fixtures, such as standard fluorescent troffers and the like. The LED lamp may conform to the recognized lighting standards, such as UL and ANSI light standards, thus providing a wholly compatible light bulb or lamp for preexisting light fixtures.

As shown in FIG. 5, in another construction, the lighting device 20 may include a secondary housing 52 for electrically coupling a standard lighting element 54, such as a standard incandescent, neon, LED or other such lighting element that may be configured to operate when primary power to the lighting device 20 is available. The lighting device 20 is configured to be coupled to a standard lighting fixture as previously discussed for supplying primary power to the lighting device 20. The lighting device 20 may be configured such that when the primary power is active, the light-emitting elements 24 are not illuminated such that only the standard lighting element 54 is illuminated.

Understandably, in the alternative, the lighting device 20 may be configured such that the standard lighting element 54 and the light-emitting elements 24 or a subset thereof are illuminated at the same time. When the transmitter 12 detects a power outage, the lighting device 54 may then be configured to switch to operate solely on light-emitting elements 24 as previously discussed. The electronics arrangement 26 and receiver 14 may be located within the secondary housing 52.

The secondary housing 52 may include one or more LEDs or other light-emitting elements disposed around a periphery of the secondary housing 52 and may be configured for providing additional illumination during a power outage. In such cases, the light-emitting elements may be replaced by a standard light source such as an incandescent or CFL bulb. Understandably, the standard lighting element 54 may still be provided as a number of LEDs housed within a lens as shown.

As previously discussed, the light emitting elements of the secondary housing 52 may be DC-LEDs which can operate directly from a DC power supply, such as a built-in or replaceable battery. In such a case, the standard lighting element 54 may include AC-LEDs, an incandescent or CFL bulb, and may operate directly from an AC power supply when primary power is provided.

Referring now to FIG. 6, another construction of the lighting device 20 is shown in which the receiver 14 is incorporated into a standard light fixture 60 of the kind known in the art. In this construction, the receiver 14 may be constructed in the manner previously described and include an electronics arrangement including means for operatively coupling the receiver 14 with the light fixture 60 for operation thereof.

The lighting device 20 may be configured as a self-contained unit that runs off the backup power source 46 and is only illuminated during a power outage. The lighting device 20 of the present construction may be configured for mounting in any location as it need not necessarily be powered off of a primary power source. In at least one construction of the present invention, the backup power source 46 is a long-life battery that is configured to consume very little power, e.g., a LiFePO4 battery. The lighting device 20 of the present construction may be configured to include a receiver 14 as in the prior embodiments but may be configured to only periodically monitor for signals from the transmitter 12 in order to save battery life.

In one construction, the lighting device 20 may additionally include at least one solar panel (not shown) configured to charge the backup power source 46. In such a construction, the lighting device 20 may be configured to be situated near a natural light source such as, near a window, etc.

Referring now to FIGS. 7A and 7B, a simplified schematic representation of the control board 40 of electronics arrangement 26 is shown. The schematic representation shows the function of the control board 40 when AC power is delivered to the lighting device. The input is direct AC input coming from, e.g., a standard power outlet (AC 120V 60 Hz or AC 220V 50 Hz) or hard-wiring. The AC input is divided into two outputs, namely, AC output (120V 60 Hz) and DC output (3V-5V). The AC output is delivered to the lighting device. The DC output charges a backup power source, such as a battery. The battery has a protective function with a standard charge and discharge setting to protect it from short circuit, overcharge, and over-discharge. There may also be a function to tell the consumer that the battery needs to be replaced, for example, an audible or visual warning, as noted above.

Connected to the control board 40 is a RF receiver module, as shown in FIG. 7B, for receiving signals or communication data. The RF receiver module has a VCC pin to provide power, a RXD pin to receive data, and a ground (GND) pin to complete the circuit and reduce electromagnetic interference. During normal operation when utility power is delivered, AC output is “on” to deliver AC power to the lighting device, and DC output is “on” to charge the battery. When the battery is fully charged, the protective feature will shut “off” DC output to the battery and keep AC output “on” to the lighting device. When the RF receiver module receives a signal that utility power has been interrupted, AC output is shut “off”, and DC output is turned back “on” so that the battery is allowed to deliver DC power to the lighting device.

The size of the control board 40 is relatively small, e.g., maximum 35.95 mm diameter×24.9 mm, and may be 30 mm diameter×15.5 mm. It is contemplated that the control board 40 may also have a transceiver, such as a ZigBee chip, to receive data communication and switch from AC power operation mode to battery operation mode. The control board 40 may also include a photosensor to conserve battery during daylight hours. It is contemplated that the control board and associated electronics are sized to be built into the body of the lighting element.

Referring now to FIGS. 7C and 7D, a simplified schematic representation of the control board 40 of electronics arrangement 26 is shown having an alternative configuration. The schematic representation shows the RF receiver module function integrated into the control board 40. As described previously, the AC input is divided into two outputs, namely, AC output (120V 60 Hz) and DC output (3V-5V). FIG. 7D shows an alternative configuration of FIG. 7C wherein the control board 40 and input/output connections may be constructed in various shapes and sizes, and disposed in various arrangements with respect to one another.

Referring now to FIG. 8, in one construction of the present invention the electronics arrangement 26 includes AC input providing power to the AC-LEDs and optionally charging the backup power supply battery. The schematic diagram of FIG. 8 shows AC input to the light engine. The light engine contains an integrated circuit, e.g., Acrich2Plus IC, and a plurality of AC-LEDs and DC-LEDs (8 W and 12 W versions of each). The AC input illuminates the AC-LEDs while rectified DC output is driven to the wireless radio, battery charger, and LED driver. Optionally, 1-10V DIM driver (allows a minimum dim level of 10%) is provided to the light engine. A charging voltage exits the battery charger/LED driver to charge the battery, e.g., Li ion battery. When AC input is not provided, constant DC is delivered from the battery to the light engine to provide power to the DC-LEDs.

Referring now to FIG. 9, in an alternative construction, AC power is rectified to DC power according to an electronics arrangement 26 provided by, e.g., control board 40 as shown in FIGS. 7A and 7B. The schematic diagram of FIG. 9 shows AC power (120V AC) entering the fuse, rectifier, transient suppressor and exiting as full-wave rectified DC power. The rectified DC power is delivered to the integrated circuit, e.g., Acrich Application-Specific Integrated Circuit (ASIC), and AC-LEDs when AC power is provided, or alternatively, to the battery, e.g. LiFePO4 battery, and DC-LEDs in the event of a power failure.

FIGS. 10-11 illustrate representative circuit diagrams showing alternative embodiments of the light engine of FIGS. 8 and 9. The light engine circuit arrangement of FIG. 10 may be used in accordance with the electronics construction of FIG. 8. The light engine circuit arrangement of FIG. 11 may be used in accordance with the electronics construction of FIG. 9.

While the alternately powered AC/DC lighting device of the present invention has been shown and described in the context of emergency lighting system 10, it is understood that emergency lighting system 10 is simply one representative application of the lighting device of the present invention. The alternate power source lighting device of the present invention may be employed in any application in which alternate power sources are available.

Various alternatives and embodiments are contemplated as being within the scope of the following claims, which particularly point out and distinctly claim the subject matter regarded as the invention.

We claim:

1. A lighting device comprising:
a light housing having an electrical connector for receiving power from an AC power source;
a battery coupled to the light housing for supplying DC battery power;
at least one light-emitting element disposed within the housing for receiving AC power from the AC power source; and
at least one light-emitting element disposed within the housing for receiving DC power from the battery.

2. The lighting device of claim 1 wherein the light-emitting elements are LEDs.

3. The lighting device of claim 1 further comprising:
a heat sink for receiving heat from the LEDs.

4. The lighting device of claim 3 wherein the heat sink is an aluminum disk.

5. The lighting device of claim 1 wherein the battery is a rechargeable battery.

6. The lighting device of claim 1 further comprising:
a receiver coupled to the lighting device and configured to receive a signal for selectively determining the power source.

7. The lighting device of claim 6 further comprising:
a transmitter which remotely transmits data to the receiver.

8. The lighting device of claim 7 wherein the transmitter is a handheld device.

9. The lighting device of claim 7 wherein the data is received over a ZigBee network.

10. A LED lamp comprising:
a lens for providing radiation of light;
at least one AC-LED selectively providing illumination through the lens;
at least one DC-LED selectively providing illumination through the lens;
a heat sink coupled to the LEDs and absorbing heat therefrom; and
a lamp base for containment of the LEDs and the heat sink.

11. The LED lamp of claim 10 further comprising:
a battery disposed within the lamp base and supplying a DC power source.

12. The LED lamp of claim 10 wherein the lamp base has a connector for receiving an electrical connection from an AC power source.

13. The LED lamp of claim 10 further comprising:
a receiver coupled to the lamp and configured to receive a signal for selectively determining the source of power.

14. A light device comprising:
a plurality of AC-LEDs;
a plurality of DC-LEDs;
an AC electrical connector for supplying AC power to the AC-LEDs; and
a battery for supplying DC battery power to the DC-LEDs.

15. The light device of claim 14 wherein the LEDs and battery are contained within a lamp assembly that includes an engagement arrangement for selectively engaging the lamp assembly within a socket.

16. The light device of claim 14 wherein the DC-LEDs and battery are contained within a base that includes an engagement arrangement for selective engagement within a socket, and wherein the AC-LEDs are carried in a lighting device separate from and engageable with the base.

17. The light device of claim 14 further comprising:
a photosensor for detecting a low light condition.

18. The light device of claim 14 wherein the battery is a rechargeable battery.

19. The light device of claim 14 wherein the light device is a down-lighting bulb.

20. The light device of claim 14 wherein the light device is a linear-lighting bulb.
